(19) United States
(12) Patent Application Publication
(10) Pub. No.: US 2021/0243599 A1
(43) Pub. Date: Aug. 5, 2021

(54) USER AUTHENTICATION METHOD THROUGH BLUETOOTH DEVICE AND DEVICE THEREFOR

(71) Applicant: LG ELECTRONICS INC., Seoul (KR)

(72) Inventors: Hyeonjae Lee, Seoul (KR); Minsoo Lee, Seoul (KR); Jingu Choi, Seoul (KR)

(21) Appl. No.: 16/972,263

(22) PCT Filed: Jul. 4, 2019
(86) PCT No.: PCT/KR2019/006697

§ 371 Date: Dec. 4, 2020

(30) Foreign Application Priority Data
Jun. 4, 2018 (KR) 10-2018-0064175

(51) Int. Cl. H04W 12/06; H04L 29/06; H04W 4/80; H04L 9/30; H04W 12/04

(52) U.S. Cl. CPC H04W 12/06; H04L 63/0861; H04W 12/04; H04L 9/30; H04W 4/80

(57) ABSTRACT

The present specification provides a method for performing a user authentication of a first client device using a server device in a wireless communication system. More specifically, the method performed by the server device comprises the steps of: broadcasting a first advertisement message for a connection with a first client; establishing a connection with the first client device; receiving, from the first client device, a first request message requesting at least one authentication method supported by the server device; transmitting, to the first client device, a first response message including first authentication method information associated with the at least one authentication method; receiving, from the first client device, a setup message including second authentication method information associated with one or more authentication methods of the at least one authentication method; and transmitting, to the first client device, a second response message including a first user authentication service (UAS) registration identifier, wherein the first UAS registration identifier indicates the first client device which performs the one or more authentication methods and a user authentication through the one or more authentication methods. Accordingly, the present specification has an effect of easily performing high security user authentication with a client device through a server device.

### TECHNICAL FIELD

The present disclosure relates to a method and device for performing user authentication using Bluetooth, which is short-range technology, in a wireless communication system, and more particularly, to a method and device for performing user authentication for use of a first device using a second device equipped with a user authentication function.

### BACKGROUND ART

Bluetooth is short-range wireless technology standard that can wirelessly connect various devices in a short distance to exchange data. In the case of performing wireless communication between two devices using Bluetooth communication, a user performs a procedure of discovering Bluetooth devices to communicate and requesting a connection thereto. In the present disclosure, a device may mean equipment or an apparatus.

In this case, the user may discover a Bluetooth device and then perform a connection thereto after according to a Bluetooth communication method to be used using the Bluetooth device.

Bluetooth communication methods include a Bluetooth Basic Rate/Enhanced Data Rate (BR/EDR) method and a Bluetooth low energy (LE) method, which is a low power method. The Bluetooth BR/EDR method may be referred to as classic Bluetooth. The classic Bluetooth method includes Bluetooth technology that has been passed down from Bluetooth 1.0 to 2.1 using a basic rate and Bluetooth technology that uses an enhanced data rate supported from Bluetooth 2.0.

Bluetooth low energy (hereinafter, referred to as Bluetooth LE) technology can stably provide information of several hundred kilobytes while consuming little power. The Bluetooth LE technology exchanges information between devices using an attribute protocol. The Bluetooth LE method can reduce energy consumption by reducing overhead of a header and simplifying operation.

Some Bluetooth devices do not have a display or a user interface. The complexity of connection/management/control/disconnection between various types of Bluetooth devices and Bluetooth devices to which similar technologies are applied, among the Bluetooth devices, is increasing.

Further, Bluetooth can achieve a relatively high speed with relatively low power and low cost, but because a transmission distance thereof is limited to a maximum 100 m, it is suitable for use in a limited space.

### DISCLOSURE

### Technical Problem

The present disclosure provides a user authentication method for a user to use a first device using a second device equipped with a user authentication function.

The present disclosure further provides a method of performing user authentication without entering a complicated password.

The present disclosure further provides a method of performing user authentication with a high security level.

The present disclosure further provides a method of registering second device information in a first device in order to perform user authentication with the first device using a second device.

The present disclosure further provides a method of performing user authentication in order to use a first device using a second device registered in the first device.

The technical problems to be achieved in the present disclosure are not limited to the above-described technical problems, and other technical problems that are not described will be clearly understood by those of ordinary skill in the technical field to which the present disclosure belongs from the following description.

### Technical Solution

A method of performing user authentication of a first client device using a server device in a wireless communication system, the method performed by the server device includes broadcasting a first advertisement message for a connection with a first client device; establishing a connection with the first client device; receiving, from the first client device, a first request message for requesting at least one authentication method supported by the server device; transmitting, to the first client device, a first response message including first authentication method information related to the at least one authentication method; receiving, from the first client device, a setting message including second authentication method information related to one or more authentication methods of the at least one authentication method; and transmitting a second response message including a first user authentication service (UAS) registration identifier to the first client device, wherein the first UAS registration identifier indicates the first client device for performing user authentication through the one or more authentication methods and the one or more authentication methods.

Further, the first advertisement message may include UAS Universally Unique Identifier (UUID) information, name information of the server device, and appearance information of the server device.

Further, the first UAS registration identifier may be generated based on a first client device identifier, a server device identifier, and the one or more authentication methods.

Further, the method may further include registering the first client device and the one or more authentication methods.

Further, the at least one authentication method may include at least one of wearing, biometric-fingerprint, biometric-IRIS, and biometric-EEG.

Further, the method may further include exchanging a public key for generating a shared key with the first client device, wherein the public key may be generated in each of the first client device and the server device.

Further, the method may further include generating the shared key based on the public key, wherein the shared key may be used for encrypting messages transmitted after the shared key is generated.

Further, the method may further include receiving, from the first client device, a first inquiry message inquiring whether the first UAS registration identifier exists; determining whether the first UAS registration identifier exists; transmitting, to the first client device, a message related to whether the first client device is registered; receiving, when the first UAS registration identifier exists, a third request message, from the first client device, for requesting first authentication status information, which is information on whether a user has been authenticated through the one or more authentication methods; and transmitting a third response message including the authentication status information to the first client device.

Further, the method may further include broadcasting, when the connection is released, a second advertisement message for a connection with the first client device; and re-establishing a connection with the first client device.

Further, when the first UAS registration identifier does not exist, the method may further include releasing the connection.

Further, messages exchanged between the first client device and the server device may be encrypted and exchanged after the inquiry message.

Further, when the authentication state information indicates that all of the one or more authentication methods have been authenticated, the method may further include receiving a session status update message indicating that a session status formed between the first client device and the server device is updated from the first client device.

Further, when the authentication state information indicates that there is an unauthenticated authentication method among the one or more authentication methods, the method may further include receiving, from the first client device, a fourth request message for requesting second authentication state information; and transmitting a fourth response message including the second authentication status information to the first client device.

Further, the method may further include receiving, from the first client device, a session status update message indicating that a session status formed between the first client device and the server device is updated; receiving, from a second client device, a second inquiry message inquiring whether a second UAS registration identifier exists; transmitting, to the second client device, a message related to whether the second client device is registered; receiving, from the second client device, a session status request message for requesting session status information about a session status formed between the first client device and the server device when the second UAS registration identifier exists; and transmitting a session status response message including the session status information to the second client device, wherein a session formed between the second client device and the server device may be updated based on the session status information.

Further, when the second UAS registration identifier does not exist, the second client device may not transmit the session status request message.

In a method of performing user authentication with a client device using a server device in a wireless communication system, the server device includes a communication unit for transmitting and receiving signals to and from the outside by wired and/or wireless means; and a control unit functionally connected to the communication unit, wherein the control unit is configured to broadcast a first advertisement message notifying the server device to the client device, to establish a connection with the first client device, to receive a first request message for requesting at least one authentication method supported by the server device from the first client device, to transmit a first response message including authentication method information related to the at least one authentication method to the client device, to receive, from the client device, a setting message including one or more authentication methods among the at least one authentication method, and to transmit a second response message including a first User Authentication Service (UAS) registration identifier to the client device, wherein the first UAS registration identifier indicates that user authentication is performed through the one or more authentication methods between the client device and the server device.

### Advantageous Effects

There is an effect of providing a user authentication method for a user to use a first device using a second device equipped with a user authentication function.

Further, the present disclosure has an effect of performing user authentication without entering a complicated password.

Further, the present disclosure has an effect of performing user authentication in a high security level.

Further, according to the present disclosure, in order to perform user authentication with the first device using the second device, it is possible to perform user authentication by registering second device information in the first device.

Further, the present disclosure has an effect of performing user authentication in order to use the first device using the second device registered in the first device.

The effects that can be obtained in the present disclosure are not limited to the above-described effects, and other effects that are not described will be clearly understood by those of ordinary skill in the art from the following description.

### DESCRIPTION OF DRAWINGS

The accompanying drawings, which are included as part of the detailed description to assist understanding of the present disclosure, will provide embodiments of the present disclosure, and describe the technical features of the present disclosure together with the detailed description.

FIG. 1 is a schematic diagram illustrating an example of a wireless communication system using Bluetooth low energy technology to which the present disclosure can be applied.

FIG. 2 illustrates an example of a method of connecting a wireless communication interface between devices in a wireless communication system to which the present disclosure can be applied.

FIG. 3 illustrates an example of a Bluetooth low energy topology in a wireless communication system to which the present disclosure can be applied.

FIG. 4 is a diagram illustrating an example of Bluetooth communication architecture in a wireless communication system to which the present disclosure can be applied.

FIG. 5 illustrates an example of an internal block diagram of a device in a wireless communication system to which the present disclosure can be applied.

FIG. 6 illustrates a disadvantage of a method of obtaining access rights through password input in a wireless communication system to which the present disclosure can be applied.

FIG. 7 illustrates an example of a method of registering a UA client device in a UA server device in a wireless communication system to which the present disclosure can be applied.

FIG. 8 is a diagram illustrating an example in which a UA server device having a method of inputting numbers and gestures performs a proximity check procedure in a wireless communication system to which the present disclosure can be applied.

FIG. 9 illustrates an example in which a UA server device having a method of outputting character strings and numbers performs a proximity check procedure in a wireless communication system to which the present disclosure can be applied.

FIG. 10 illustrates an example of a usage phase using a UA server device in a wireless communication system to which the present disclosure can be applied.

FIG. 11 illustrates an example of a communication channel encryption method in a wireless communication system to which the present disclosure can be applied.

FIG. 12 illustrates an example of UA server device and UA client device information used in a usage phase in a wireless communication system to which the present disclosure can be applied.

FIG. 13 is a diagram illustrating an example of a process of performing user authentication of a UA client device using a UA server device in a wireless communication system to which the present disclosure can be applied.

FIG. 14 illustrates another example of a process of performing user authentication of a UA client device using a UA server device in a wireless communication system to which the present disclosure can be applied.

FIG. 15 illustrates an example of a method of performing a usage phase with a plurality of UA client devices through a single UA server device in a wireless communication system to which the present disclosure can be applied.

FIG. 16 illustrates an example of a method of enabling another UA client device to use another user authentication means using a device that performs both roles of a UA server device and a UA client device in a wireless communication system to which the present disclosure can be applied.

FIG. 17 illustrates an example of a process of updating a session status between a UA server device and a UA client device in a wireless communication system to which the present disclosure can be applied.

FIG. 18 illustrates another example of a process of updating a session status between a UA server device and a UA client device in a wireless communication system to which the present disclosure can be applied.

FIG. 19 illustrates examples in which user authentication of a UA client device using a UA server device fails in a wireless communication system to which the present disclosure can be applied.

### MODE FOR DISCLOSURE

The aforementioned objects, features and advantages of the present disclosure will become more apparent through the following detailed description with respect to the accompanying drawings. Hereinafter, the embodiments of the present disclosure will be described with reference to the accompanying drawings, in which like numbers refer to like elements throughout the specification. In describing the present disclosure, a detailed description of known techniques associated with the present disclosure unnecessarily obscure the gist of the present disclosure, it is determined that the detailed description thereof will be omitted.

Hereinafter, a method and a device related to the present disclosure will be described in detail with reference to the accompanying drawings. In the following description, usage of suffixes such as ‘module’, ‘part’ or ‘unit’ used for referring to elements is given merely to facilitate explanation of the present disclosure, without having any significant meaning by itself.

Electronic devices described in the present disclosure may include a mobile phone, a smart phone, a laptop computer, a digital broadcasting terminal, a personal digital assistant (PDA), a portable multimedia player (PMP), a navigation device, and the like. However, it will be readily apparent to those skilled in the art that a configuration according to the embodiment described in the present disclosure may be applied to a fixed terminal such as a digital television or a desktop computer, except when applicable only to a mobile terminal.

Signals described in this specification may be transmitted not only in the form of a message but also in the form of a frame, and a wireless communication interface and a wireless communication means are given or used interchangeably in consideration of only the ease of preparation of the specification, and do not themselves have distinct meanings or roles.

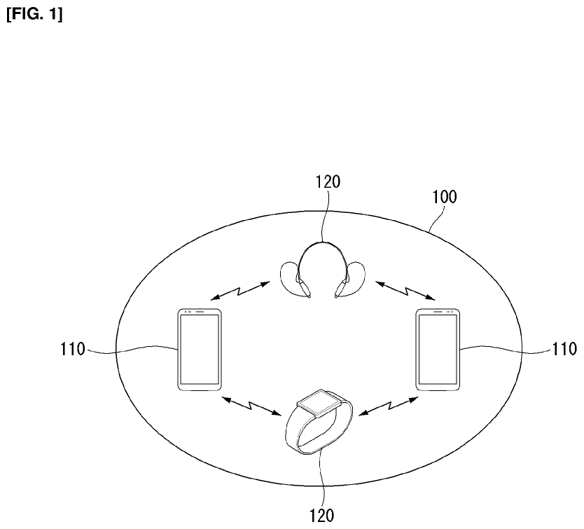

FIG. 1 is a schematic diagram illustrating an example of a wireless communication system using Bluetooth low energy (BLE) technology to which the present disclosure may be applied.

A wireless communication system 100 includes at least one server device 110 and at least one client device 120.

The server device and the client device perform Bluetooth communication using a BLE technology.

First, BLE technology has a relatively small duty cycle, may be produced at low cost, and significantly reduces power consumption through a low data rate, and thus, it is possible to operate for more than a year in the case of using a coin cell battery, compared to Bluetooth basic rate/enhanced data rate (BR/EDR) technology.

In addition, the BLE technology simplifies a connection process between devices, and a packet size is smaller than that of the Bluetooth BR/EDR technology.

In BLE technology, (1) the number of RF channels is 40, (2) 1 Mbps is supported as a data rate, (3) topology is a star structure, (4) latency is 3 ms, and (5) a maximum current is 15 mA or less, (6) output power is 10 mW (10 dBm) or less, and (7) the BLE technology is mainly used in applications such as mobile phones, watches, sports, healthcare, sensors, device control, and the like.

The server device 110 may operate as a client device in a relationship with other devices, and the client device may operate as a server device in a relationship with other devices. That is, in the BLE communication system, any one device may operate as a server device or a client device, and may operate as both a server device and a client device, if necessary.

The server device 110 may be represented as a data service device, a master device, a master, a server, a conductor, a host device, an audio source device, and a first device the like, and the client device may be represented as a slave device, a slave, a client, a member, a sink device, an audio sink device, a second device and the like.

The server device and the client device correspond to main components of the wireless communication system, and the wireless communication system may include other components in addition to the server device and the client device.

The server device refers to a device which is provided with data from the client, directly communicates with the client device, and provides data to the client device through a response when a data request is received from the client.

In addition, the server device sends a notification message and an indication message to the client device to provide data information to the client device. In addition, when the server device transmits the indication message to the client device, the server device receives a confirmation message corresponding to the indication message from the client.

In addition, in the process of transmitting and receiving the notification message, the indication message, and the confirmation message to and from the client device, the server device may provide data information to a user through a display unit or may receive a request input from a user through a user input interface.

In addition, the server device may read data from a memory unit or write new data to the corresponding memory in the process of transmitting and receiving a message to and from the client device.

In addition, one server device may be connected to a plurality of client devices and may be easily reconnected (or connected) with client devices by using bonding information.

The client device 120 refers to a device that requests data information and data transmission from the server device.

The client device receives data from the server device through the notification message, the indication message, and the like, and when the indication message is received from the server device, the client device sends a confirmation message in response to the indication message.

Similarly, the client device may provide information to the user through an output unit or receive an input from the user through the input unit in the process of transmitting and receiving a message to and from the server device.

In addition, the client device may read data from a memory or write new data into the corresponding memory in the process of transmitting and receiving a message to and from the server device.

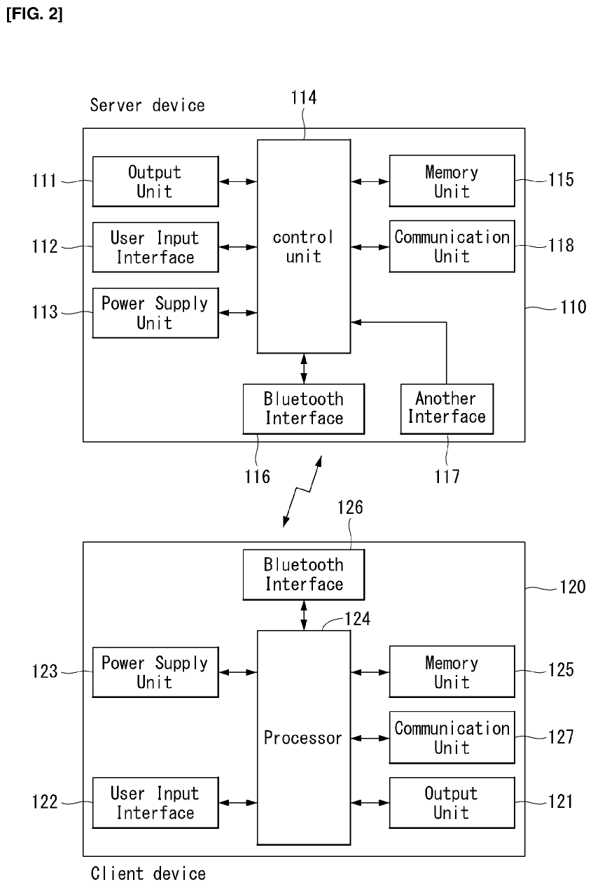

Hardware components such as the output unit, the input unit, and the memory of the server device and the client device will be described in detail with reference to FIG. 2.

In addition, the wireless communication system may configure personal area networking (PAN) through Bluetooth technology. For example, in the wireless communication system, files, documents, and the like may be exchanged quickly and safely by establishing a private piconet between devices.

The BLE device may be operable to support various Bluetooth-related protocols, profiles, processing, and the like.

In addition to the BLE, the electronic device including the BLE technology includes a number of wireless communication interfaces such as Wi-Fi, Bluetooth BR/EDR, and NFC.

Because it is difficult to predict when a connection with a counterpart device will occur for these various wireless communication interfaces, most electronic devices use a number of wireless communication interfaces while always maintaining a wake up state.

These communication interfaces have a technical solution to minimize standby power within an idle time, and an energy-efficient performance thereof is also excellent, but with the advancement of technology, there is clearly a limit to always keeping all wireless communication interfaces that will be newly created in the future in a wake-up state, and this problem may become more serious in devices with battery limitations.

In order to overcome this problem, the present disclosure proposes a method of using BLE as a wake-up interface and waking up another wireless communication interface only when being requested.

FIG. 2 illustrates an example of an internal configuration diagram of a server device and a client device proposed in the present disclosure.

As illustrated in FIG. 2, the server device includes an output unit 111, a user input interface 112, a power supply unit 113, a processor 114, a memory unit 115, a Bluetooth interface 116, another communication interface 117, and a communication unit (or a transceiver 118).

The output unit 111, the user input interface 112, the power supply unit 113, the processor 114, the memory unit 115, the Bluetooth interface 116, the another communication interface 117, and the communication unit 118 are functionally connected to perform a method proposed in the present disclosure.

Further, the client device includes an output unit 121, a user input interface 122, a power supply unit 123, a processor 124, a memory unit 125, a Bluetooth interface 126, and a communication unit (or a transceiver 127).

The output unit 121, the user input interface 122, the power supply unit 123, the processor 124, the memory unit 125, the Bluetooth interface 126, and the communication unit 127 are functionally connected to perform the method proposed in the present disclosure.

The Bluetooth interfaces 116 and 126 refer to units (or modules) capable of transmitting a request/response, command, notification, instruction/confirmation message, etc. or data between devices using Bluetooth technology.

The memory units 115 and 125 are units implemented in various types of devices, and refer to units in which various types of data are stored.

The processors 114 and 124 refer to a module that controls the overall operation of a server device or a client device, and controls to process a transmission request message and a received message with a Bluetooth interface and other communication interfaces.

The processors 114 and 124 may be represented as a control unit or a controller.

The processors 114 and 124 may include application-specific integrated circuits (ASICs), other chipsets, logic circuits, and/or data processing devices.

The processors 114 and 124 control the communication unit to receive an advertising message including information related to a service supported by the server device from the server device, transmit a scan request message to the server device, control the communication unit to receive a scan response message in response to the scan request from the server device, and control the communication unit to transmit a connect request message to the server device in order to establish a Bluetooth connection with the server device.

The memory units 115 and 125 may include a read-only memory (ROM), random access memory (RAM), flash memory, memory card, storage medium, and/or other storage device.

The communication units 118 and 127 may include a baseband circuit for processing a radio signal. When the embodiment is implemented with software, the above-described technique may be implemented with a module (process, function, etc.) that performs the above-described functions. The modules may be stored in the memory unit and be executed by the processor.

The memory units 115 and 125 may be inside or outside the processors 114 and 124, and be connected to the processors 114 and 124 by various well-known means.

The output units 111 and 121 refer to modules for providing status information and message exchange information of the device to a user through a screen.

The power supply units 113 and 123 refer to a module that receives external power and internal power under the control of the control unit and that supplies power necessary for the operation of each component.

As described above, BLE technology has a small duty cycle, and can greatly reduce power consumption through a low data rate and thus the power supply unit may supply power required for operation of each component even with small output power (10 mW (10 dBm) or less).

The user input interfaces 112 and 122 refer to a module that provides a user's input to the controller, such as a screen button to enable the user to control the operation of the device.

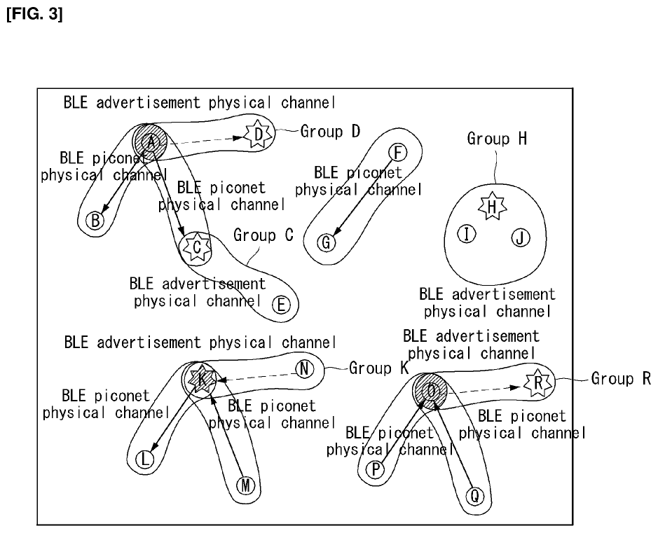

FIG. 3 is a view illustrating an example of a Bluetooth low energy topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slave does not share a common physical channel with the master. Each of the slaves communicates with the master trough a separate physical channel. There is another piconet (piconet F) having a master device F and a slave device G.

A device K is present in a scatter net K. Here, the scatter net refers to a group of piconets connected to other piconets.

The device K is a master of a device L and a slave of a device M.

A device O is also in the scatter net O. The device O is a slave of a device P and a slave of a device Q.

As illustrated in FIG. 3, five different device groups are present.

Device D is an advertiser and device A is an initiator (group D).

Device E is a scanner and Device C is an advertiser (group C).

Device H is an advertiser, and devices I and J are scanners (group H).

Device K is also an advertiser, and device N is an initiator (group K).

Device R is an advertiser, and device O is an initiator (group R).

The devices A and B use a single BLE piconet physical channel

The devices A and C use another BLE piconet physical channel

In group D, the device D advertises using an advertising event connectable in an advertisement physical channel, and the device A is an initiator. The device A may establish a connection with the device D and add a device to the piconet A.

In group C, the device C advertises on an advertisement physical channel by using a certain type of an advertising event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel

In group K, the device K advertises by using an advertising event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel

In group R, the device R advertises by using an advertising event connectable on an advertisement physical channel, and the device O is an initiator. The device O may establish a connection with the device R. Here, the device O may be a slave of two devices and a master of one device at the same time.

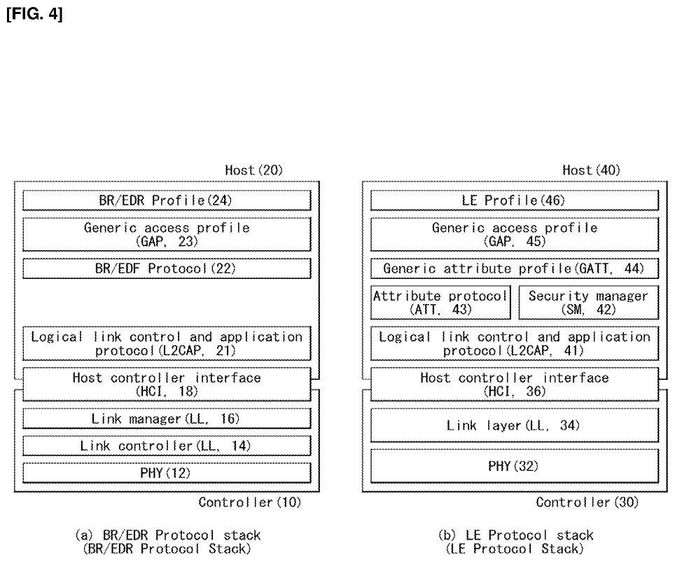

FIG. 4 is a view illustrating an example of a Bluetooth communication architecture proposed in this disclosure.

With reference to FIG. 4, FIG. 4(a) illustrates one example of protocol stack of Bluetooth BR (Basic Rate)/EDR (Enhanced Data Rate), and FIG. 4(b) illustrates one example of a protocol stack of Bluetooth LE (Low Energy).

In detail, as illustrated in (a) of FIG. 4, the Bluetooth BR/EDR protocol stack may include an upper controller stack 10 and a lower host stack 20 with respect to a host controller interface (HCI) 18.

The host stack (or host module) 20 refers to hardware for transmitting or receiving a Bluetooth packet to and from a wireless transceiver module receiving a Bluetooth signal of 2.4 GHz, and is connected to a Bluetooth module, the controller stack 10, to control the Bluetooth module and performs an operation.

The host stack 20 may include a BR/EDR PHY layer 12, a BR/EDR Base band layer (14) and a link manager layer (Link Manager, 16).

The BR/EDR PHY layer 12 is a layer transmitting and receiving a 2.4 GHz wireless signal, and in case of using Gaussian frequency shift keying (GFSK) modulation, the BR/EDR PHY layer 12 may transmit data by hopping 79 RF channels.

The BR/EDR Baseband layer 14 serves to transmit a digital signal, selects a channel sequence hopping 1400 times per second, and transmits a time slot having a length of 625 us for each channel.

The link manager layer 16 controls a general operation (link setup, control, security) of a Bluetooth connection by utilizing a link manager protocol (LMP).

The link manager layer 16 may perform the following functions.
The link manager layer 16 may perform ACL/SCO logical transport, logical link setup, and control.
Detach: The link manager layer 16 stops connection and informs a counterpart device about the reason for stopping connection.
The link manager layer 16 performs power control and role switch.
The link manager layer 16 performs security (authentication, pairing, encryption) function.

The host controller interface layer 18 provides the interface between the Host module and the Controller module to allow the host to provide the command and the data to the controller and the controller to provide the event and the data to the host.

The host stack (or host module) 20 includes a logical link control and adaptation protocol (L2CAP) 21, a BR/EDR protocol 22, a generic access profile (GAP, 23), and a BR/EDR profile 24.

The logic link control and adaptation protocol (L2CAP) 21 may provide one bidirectional channel for transmitting the data to a specific protocol or profile.

The L2CAP 21 may multiplex various protocols, profiles, and the like provided in a higher Bluetooth layer.

The L2CAP of the Bluetooth BR/EDR uses a dynamic channel, supports a protocol service multiplexer, retransmission, and a streaming mode, and provides segmentation, reassembly, per-channel flow control, and error control.

The BR/EDR Protocol 22 and Profiles 24 define a service (profile) using Bluetooth BR/EDR and an application protocol for exchanging these data, and the generic access profile (GAP) 23 defines a method of device discovery, connection, and information provision to users, and provides privacy.

As illustrated in FIG. 4(b), the Bluetooth LE protocol stack includes a controller stack 30 which is operable to process a wireless device interface of which a timing is important and a host stack 40 which is operable to process high-level data.

First, the controller stack 30 may be implemented by using a communication module which may include a Bluetooth wireless apparatus, for example, a processor module which may include a processing device such as a microprocessor.

The host stack may be implemented as a part of an OS which operates on the processor module or instantiation of a package above the OS.

In some cases, the controller stack and the host stack may be actuated or executed on the same processing device in the processor module.

The controller stack 30 includes a physical layer (PHY) 32, a link layer 34, and a host controller interface 36.

The physical layer (PHY) (wireless transceiving module) 32 as a layer that transceives a 2.4 GHz wireless signal uses Gaussian frequency shift keying (GFSK) modulation and a frequency hopping technique constituted by 40 RF channels.

The link layer 34 that serves to transmit or receive a Bluetooth packet performs advertising and scanning functions by using three advertising channels and thereafter, provides functions to generate a device-to-device connection and transmit and receive a data packet of a maximum of 42 bytes through 37 data channels.

In the present disclosure, information for a connection procedure of another wireless communication interface other than the BLE may be exchanged between devices using such an advertising or scanning function, and a connection procedure of the another wireless communication interface may be performed based on the exchanged information.

The host stack may include Generic Access Profile (GAP) 40, a logic link control and adaptation protocol (L2CAP) 41, a security manager (SM) 42, an attribute protocol (ATT) 440, a generic attribute profile (GATT) 44, a generic access profile 25, and an LT profile 46. However, the host stack 40 is not limited thereto and the host stack 40 may include various protocols and profiles.

The host stack may multiplex various protocols, profiles, and the like provided in the higher Bluetooth layer by using the L2CAP.

First, the logic link control and adaptation protocol (L2CAP) 41 may provide one bidirectional channel for transmitting the data to a specific protocol or profile.

The L2CAP 41 is operable to multiplex the data among higher layer protocols, segment and reassemble packages, and manage multicast data transmission.

In the Bluetooth LE, three fixed channels (one for a signaling CH, one for the security manager, and one for the attribute protocol) are used.

On the contrary, in basic rate/enhanced data rate (BR/EDR), the dynamic channel is used and the protocol service multiplexer, the retransmission, the streaming mode, and the like are supported.

The security manager (SM) 42 is a protocol for authenticating the device and providing key distribution and manages overall Bluetooth LE security.

The attribute protocol (ATT) 43 defines a rule for accessing data of a counter device in a server-client structure. The ATT includes six following message types (request, response, command, notification, indication, and confirmation).

\textcircled{1} Request and Response message: a request message refers to the message used by a client device to request specific information to a server device, and a response message refers to the message transmitted by the server device to the server device in response to the request message.

\textcircled{2} Command message: a message transmitted from a client device to a server device to command a specific operation. The server device does not transmit a response to the command message to the client device.

\textcircled{3} Notification message: It is a message transmitted from the server device to the client device in order to notify an event, or the like. The client device does not transmit a confirmation message with respect to the notification message to the server device.

\textcircled{4} Indication and confirmation message: It is a message transmitted from the server device to the client device in order to notify an event, or the like. Unlike the notification message, the client device transmits a confirmation message regarding the indication message to the server device.

The generic access profile 45 as a layer newly implemented for the Bluetooth LE technology is used for selecting a role for communication among Bluetooth LE devices and control how multi profiles are actuated.

Further, the generic access profile (GAP) 45 is primarily used in device discovery, connection creation, and security procedure parts and defines a scheme for providing the information to the user and defines the type of the attribute.

\textcircled{1} Service: It defines a basic operation of a device by a combination of behaviors related to data

\textcircled{2} Include: It defines a relationship between services

\textcircled{3} Characteristics: It is a data value used in a server

\textcircled{4} Behavior: It is a format that may be read by a computer defined by a UUID (value type).

The LE profile 46 has a dependency on the GATT and is used mainly for Bluetooth LE devices. For example, the LE profile 46 includes Battery, Time, FindMe, Proximity, Time, Object Delivery Service and the like; specific contents of the GATT-based profiles are as follows.

Battery: Battery information exchanging method

Time: Time information exchanging method

FindMe: Provision of alarm service according to distance

Proximity: Battery information exchanging method

Time: Time information exchanging method

The generic attribute profile (GATT) 44 is operable as a protocol for describing how the attribute protocol 43 is used at the time of setting the services. For example, the generic attribute profile (GATT) 44 is operable to regulate how ATT attributes are together grouped by the services and operable to describe features associated with the services.

Therefore, the generic attribute profile 44 and the attribute protocol (ATT) 43 may use the features in order to describe the status of the device and the services and describe how the features are associated with each other and how the features are used.

Hereinafter, the procedures of the Bluetooth low energy (BLE) technology will be described in brief.

The BLE procedures may be divided into a device filtering procedure, an advertising procedure, s scanning procedure, a discovering procedure, a connecting procedure, and the like.

As illustrated in FIG. 4, the device may support only the Bluetooth BR/EDR or LE and may operate in a dual mode supporting both the Bluetooth BR/EDR and LE.

A device operating in the dual mode may establish a security connection through secure simple pairing with the device supporting only the BR/EDR through a link manager, and establish a security connection through a security manager with the device supporting only the LE.

Hereinafter, the procedures of the Bluetooth low energy (BLE) technology will be described in brief.

The BLE procedures may be divided into a device filtering procedure, an advertising procedure, s scanning procedure, a discovering procedure, a connecting procedure, and the like.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertising event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertising procedure to perform undirected broadcast to devices within a region.

Here, undirected broadcast refers to broadcasting in all directions rather than in a specific direction.

On the other hand, directed broadcast refers to broadcasting in a specific direction. Undirected broadcast is performed without involving a connection procedure between an advertising device and a device in a listening state (in what follows, it is called a listening device).

The advertising procedure is used to establish a Bluetooth connection with an initiating device nearby.

Or, the advertising procedure may be used to provide periodical broadcast of user data to scanning devices performing listening in an advertising channel

In the advertising procedure, all the advertisements (or advertising events) are broadcast through an advertisement physical channel

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of data from advertising devices using an advertising physical channel

The scanning device transmits a scan request to an advertising device through an advertising physical channel in order to request additional data from the advertising device.

The advertising device transmits a scan response as a response with respect to the scan request, by including additional data which has requested by the scanning device through an advertising physical channel

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device perestablishing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADV_SCAN_IND: Scannable undirected advertising event

The PDUs are transmitted from the LL in an advertising state, and received by the

LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

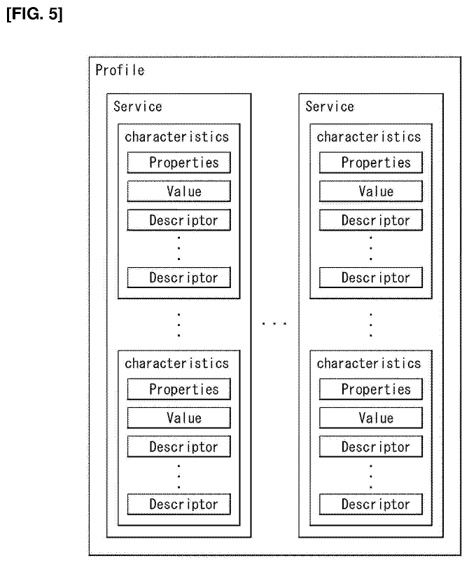

FIG. 5 is a diagram illustrating an example of a structure of a GATT of BLE.

A structure for exchanging profile data of BLE will be described with reference to FIG. 5.

Specifically, the GATT defines a method of exchanging data using services and characteristics between Bluetooth LE devices.

In general, a peripheral device (e.g., a sensor device) acts as a GATT server and has definitions of services and characteristics.

A GATT client send a data request to the GATT server to read or write data, and all transactions begin at the GATT client and a response is from the GATT server.

The GATT-based operation structure used in the Bluetooth LE is based on a profile, a service, and a characteristic and may have a vertical structure as shown in FIG. 5.

The profile includes one or more services, the one or more services may include one or more characteristics or other services.

The service serves to divide data into logical units and may include one or more characteristics or other services. Each service has a 16-bit or 128-bit identifier called a universal unique identifier (UUID).

The characteristic is the lowest level unit in the GATT-based operation structure. The characteristic includes only one data and has a 16-bit or 128-bit UUID similar to the service.

The characteristic is defined as a value of various pieces of information and requires one attribute to include each information. The characteristic may use various continuous attributes.

The attribute includes four components and has the following meaning.
handle: address of attribute
Type: Type of attribute
Value: Value of attribute
Permission: authority to access attribute

Determining whether a user accessing to a device, network, or system is a legitimate user is referred to as User Authentication (UA).

In order to obtain access rights to devices such as notebook computers or door locks, users generally set a password to devices such as the notebook computers or the door locks, and then enter the above set passwords to obtain access rights.

User authentication by entering a password causes inconvenience to the user.

Further, the more complex passwords are set to increase security, the more mistakes the user enters the password.

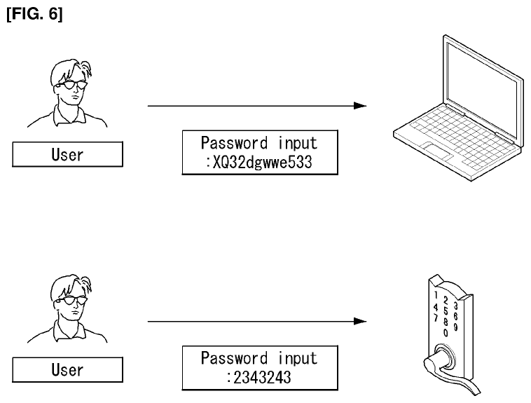

FIG. 6 is a diagram illustrating an example of a method of obtaining access rights through password input.

In FIG. 6, in order to obtain access rights to notebook computers or door locks, a user sets a password, which is a means that may easily use, and obtains access rights by inputting the set password.

In order to increase the difficulty of the password, the user sets a password, which is an unnatural language or sets the order or length of words to be long.

It is difficult for users to remember these complex passwords, and mistakes may occur when entering the password.

In order to solve a problem of user authentication through password input as described above, it is necessary to consider a method capable of performing user authentication with an easy (or convenient) enhanced security level.

To this end, the present disclosure proposes (1) a method (method (1)) of registering an original device in a second device.

Further, the present disclosure proposes (2) a method (method (2)) of obtaining use rights for an original device using a registered second device.

In the present disclosure, the original device is a device to be used when a user obtains access rights and performs actual works.

Examples of the original device may include a notebook computer, a television, and a smartphone.

The original device may also be represented as a UA client device, a client device, or a first device.

The second device is a device to be used for obtaining a user's access right to the original device.

Examples of the second device may include a smart watch, a wearable device, and a smart phone.

The second device may also be represented as a UA server device or a server device.

The user authentication may be simply represented as user authentication (UA).

Providing the user authentication using Bluetooth communication is referred to as a user authentication service (UAS).

The above method (1) may be represented in terms of a registration method or a registration phase.

The above method (2) may be represented in terms of a use method or a usage phase.

Hereinafter, a method of improving the usability and security level of a UA client device through a UA server device equipped with a user authentication function proposed by the present disclosure will be described.

For convenience of description, the method (1) will be described first and then the method (2) will be described.

Registration Phase-Method (1)

Hereinafter, first, a phase (method) (registration phase (method)) of registering a UA client device in a UA server device will be outlined, and then detailed operations between the UA server device and the UA client device in the registration phase will be described in detail.

General Registration Phase

The registration phase means that the user registers a new UA client device in the UA server device, or registers a new UA server device in the UA client device.

Hereinafter, the description will focus on the operation of registering a new UA client device in the UA server device.

In the registration phase, first, the UA client device and the UA server device share an encryption key through a public key exchange mechanism and set a security channel

Thereafter, the UA server device receives a request message for requesting available authentication methods (AAM) from the UA client device.

The request message may also be represented as an authentication method request message or an AAM request message.

More specifically, when an application program of the UA client device is already installed in the UA client device, the user requests an available authentication method to the UA server device using the UA client application program.

After receiving the authentication method request message, the UA server device transmits a response message to the authentication method request message to the UA client device.

The response message may also be represented as an authentication method response message.

The authentication method response message includes at least one available authentication method (information on at least one authentication method) in the UA server device.

Thereafter, the UA client device selects some of the at least one available authentication method.

The chosen authentication method may be selected by the user.

The UA server device receives a message including the chosen authentication method (the chosen authentication method information) from the UA client device.

The message may also be represented as an authentication method setting message.

The chosen authentication method is used as an authentication method for user authentication of the UA client using the UA server device in a subsequent usage phase.

Thereafter, after receiving the authentication method setting message, the UA server device generates a user authentication service registration ID (UAS-Registered-ID) based on the UA client device ID information, the UA server device (i.e., itself) ID information, and the chosen authentication method.

The UA server device transmits a response message including the UAS-Registered-ID to the UA client device.

The response message may also be represented as an authentication method setting response message.

In the subsequent usage phase (i.e., the user authentication phase in the UA client device using the UA server device), the UAS-Registered-ID is used as a query parameter.

Thereafter, the UA server device registers the UA client device and the UAS-Registered-ID of the UA client device.

General Registration Sequence

Hereinafter, a method of registering the UA server device in the UA client device will be described in more detail.

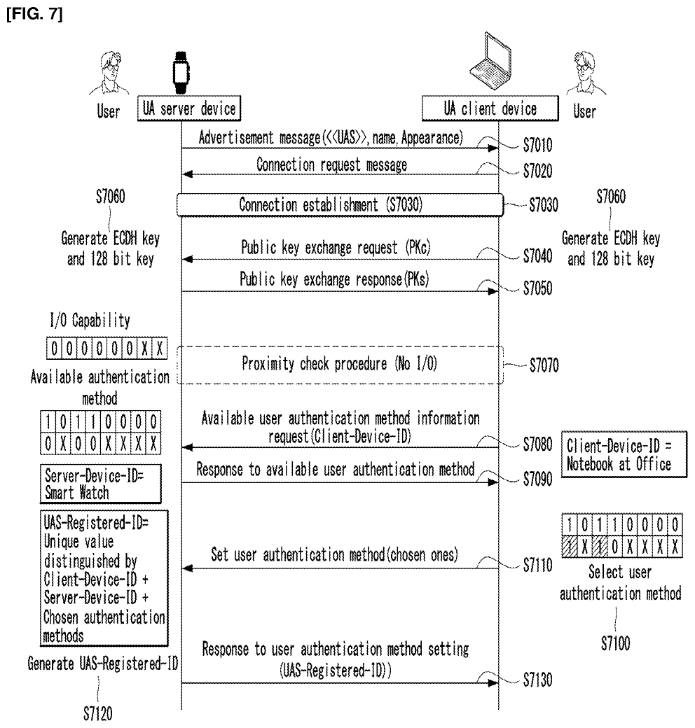

FIG. 7 is a diagram illustrating an example of a method of registering a UA client device in a UA server device.

FIG. 7 illustrates a user, a UA server device (smart watch), and a UA client device (notebook computer).

The user attempts to log in (to perform user authentication) to the UA client device (notebook computer) through an authentication method of the UA server device (smart watch).

In order for the user to log in to the UA client device using the UA server device, the registration phase should be completed first.

Prior to starting the registration phase, the user should pre-install an UA client application in the UA client device.

When the registration phase is started, the UA server device broadcasts an advertisement message including information notifying itself to the UA client device (S7010).

The advertisement message may include a user authentication service universally unique identifier (UAS UUID), a name of the UA server device, and appearance information of the UA server device.

The UA client device may easily recognize the UA server device based on the UAS UUID, the name of the UA server device, and the appearance of the UA server device.

The UA client device performs scanning in order to discover the UA server device.

After discovering the UA server device, the UA client device transmits a connection request message to the UA server device.

The UA server device receives the connection request message from the UA client device (S7020).

The connection may be a Bluetooth Low Energy (BLE) connection.

Further, the connection may be various connections using Bluetooth technology in addition to the BLE connection.

The UA server device establishes a connection with the UA client device (S7030).

In order to identify a legitimate user before the UAS registration phase is started, the

UA client device may request the user to enter a password or numeric key thereof.

That is, before the above step S7010 is started, the UA client device may request the user to input a password or numeric key thereof.

The password and the numeric key may be negotiated in advance between the UA client device and the user before starting the registration phase.

After the connection between the UA server device and the UA client device is established, the UA server device and the UA client device perform subsequent steps for registration.

In this case, it may be necessary to encrypt the entire registration transaction in order to maintain security.

That is, for registration, all messages in which the UA server device exchanges with the UA client device may be encrypted (i.e., over an encrypted channel) and transmitted and received.

Specifically, the UA server device receives a public key exchange request message for requesting a public key exchange from the UA client device (S7040).

Thereafter, the UA server device, having received the public key exchange request message transmits a public key exchange response message to the UA client device (S7050).

Through the above steps S7040 and S7050, an Elliptic Curve (EC) public key is exchanged between the UA server device and the UA client device.

Thereafter, the UA server device and the UA client device individually generate an Elliptic Curve Diffie Hellman (ECDH) key (256 bits), and obtain a shared encryption key (128 bits) from the ECDH key (S7060).

All messages exchanged between the UA server device and the UA client device for registration are encrypted using the shared key.

To all the messages, a message authentication code (MAC) may be attached for data integrity.

Through these steps S7040 to S7060, there is an effect that all messages in which the UA server device exchanges registration with the UA client device can be safely exchanged without being exposed to other devices.

Thereafter, the UA server device may perform a proximity check procedure with the UA client device (S7070).

The proximity check procedure may be selectively performed.

The proximity check procedure is a procedure in which the UA client device reads an I/O capability characteristic of the UA server device to determine whether the UA server device is adjacent thereto and to determine whether the UA client device is being registered in the UA server device.

In the example of FIG. 7, because the UA server device does not have I/O capability, the UA client device does not perform a proximity check procedure.

Thereafter, the UA server device receives, from the UA client device, a request message for requesting available authentication methods (AAM) in the UA server device (S7080).

The request message may also be represented as an authentication method request message or an AAM request message.

The authentication method request message may include an identifier (Client-Device-ID parameter) of the UA client device.

The UA server device transmits a response message to an available authentication method request message to the UA client device (S7090).

The response message may also be represented as an authentication method response message or an AAM response message.

The authentication method response message includes information on at least one authentication method available in the UA server device.

The at least one authentication method may be wearing, biometric-fingerprint, biometric-IRIS, biometric-electroencephalogram (EEG), or the like.

The authentication methods are only examples, and there may be various authentication methods in addition to these methods.

In the example of FIG. 7, the UA server device transmits an authentication method response message including three authentication methods of wearing (first bit), biometric-fingerprint (third bit), and biometric-IRIS (fourth bit).

The available methods are only one example, and the UA server device may include more available authentication methods.

Thereafter, the UA client device selects at least one user authentication method from among available methods received from the UA server device (S7100).

The user authentication method selected by the UA client device is used as a method for user authentication in a subsequent usage phase.

In the example of FIG. 7, the UA client selects wearing (first bit) and biometric-fingerprint (third bit) from wearing (first bit), biometric-fingerprint (third bit), and biometric-IRIS (fourth bit).

The selected methods are only an example, and the UA client device may select different authentication methods from the above authentication methods.

For example, the UA client device may select only wearing (first bit) from wearing (first bit), biometric-fingerprint (third bit), and biometric-IRIS (fourth bit) as a user authentication method.

Alternatively, the UA client device may select biometric-fingerprint (third bit) and biometric-IRIS (fourth bit) from wearing (first bit), biometric-fingerprint (third bit), and biometric-IRIS (fourth bit) as user authentication methods.

Alternatively, the UA client device may select all of wearing (first bit), biometric-fingerprint (third bit), and biometric-IRIS (fourth bit).

Thereafter, the UA server device receives a Set Authentication Method (SAM) message including information on the chosen authentication method from the UA client device (S7100).

The message may also be represented as an SAM message.

In the example of FIG. 7, in a bit string illustrated in step S7100, a bit 1 means selected and a bit 0 means not selected.

Conversely, it may mean that the bit 0 is selected, and it may mean that the bit 1 is not selected.

Thereafter, after receiving the authentication method setting message, the UA server device generates a UAS-Registered-ID (S7120).

The UAS-Registered-ID means that the UA client device and the authentication method selected by the UA client device in the registration phase are registered in the UA server device.

Further, the UAS-Registered-ID indicates that the user authentication is performed between the UA client device and the UA server device through the chosen authentication method.

The UAS-Registered-ID may be generated based on UA client device ID information, UA server device ID information, and authentication method information selected by the UA client device.

The above information is an example, and the UAS-Registered-ID may be generated based on other information related to the UA client device or the UA server device in addition to UA client device ID information, UA server device ID information, and authentication method information selected by the UA client device.

Thereafter, the UA server device completes the registration phase by transmitting a response message including the UAS-Registered-ID to the UA client device (S7130).

The response message may also be represented as an authentication method setting response message.

Optional Proximity Check Procedure

In the case of FIG. 7 described above, because the UA server device did not support an I/O capability, the UA client device did not perform a proximity check procedure in the registration phase.

When the UA server device supports I/O capability, the UA client device may read an I/O capability characteristic of the UA server and perform appropriate steps for proximity check.

The proximity check procedure is not a strong Man In The Middle attack (MITM attack) protection, compared to a core security manager combined with public key exchange.

That is, the UA client device may simply determine whether the UA server device is close to the UA client device through a proximity check procedure.

Further, the UA client device may simply determine whether the UA server device is registered.

When the core security manager matches the I/O capability in order to prevent MITM attacks, it may be desirable to omit an I/O capability check at an application layer.

That is, when the I/O capability check is performed in even the application layer, the user is asked to input a similar user input (UI), and confusion may occur.

Unlike the I/O capability match of the core security manager to prevent MITM attacks, the I/O function check is performed only in the UA server.

UA servers such as smart watches and smart bands mainly have numeric displays, but seldom have numeric input.

Therefore, a proximity check procedure using an output method is preferable for UA server devices such as the smart watch and the smart band.

UA client devices such as notebook computers, televisions, and smart phones generally have inputs/outputs.

However, it is assumed that UA client devices such as vehicles or door locks that do not have inputs/outputs are connected to the smartphone while they are registered.

The smart phone connected to the UA client devices that do not have inputs/outputs performs necessary UI steps for the UA client device.

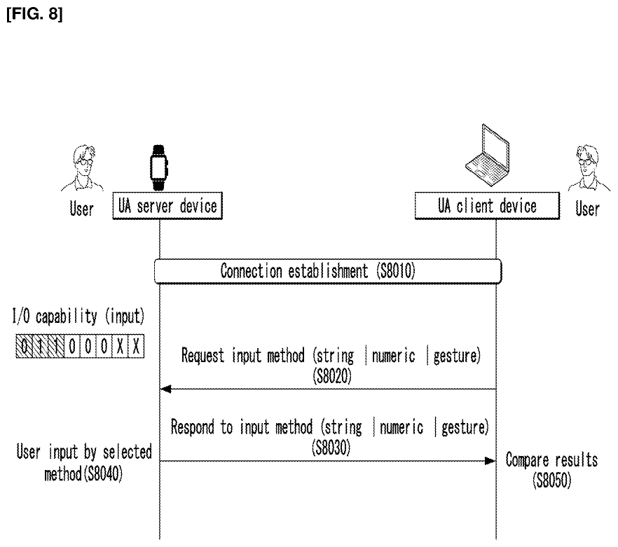

FIG. 8 is a diagram illustrating an example in which a UA server device having a method of inputting numbers and gestures performs a proximity check procedure.

In FIG. 8, a bit string indicating an I/O capability of the UA server device is illustrated, and a bit ‘1’ indicates that the I/O capability is provided, and a bit ‘0’ indicates the opposite.

In FIG. 8, it can be seen that the UA server device has two types of I/O input capabilities.

First, the UA server device establishes a connection with the UA client device (S8010).

Thereafter, the UA server device receives a request message for requesting an input method and an input value from the UA client device (S8020).

Thereafter, the user of the UA server device performs a user input by the requested method (S8040).

For example, when the input method request message requests a number input, the user inputs a number.

Thereafter, the UA server device transmits an input method response message to the UA client device (S8050).

Thereafter, the UA client device compares whether a value requested by itself and a value input by the user received from the UA server device match (S8050).

If the above values match, the proximity check procedure is successful.

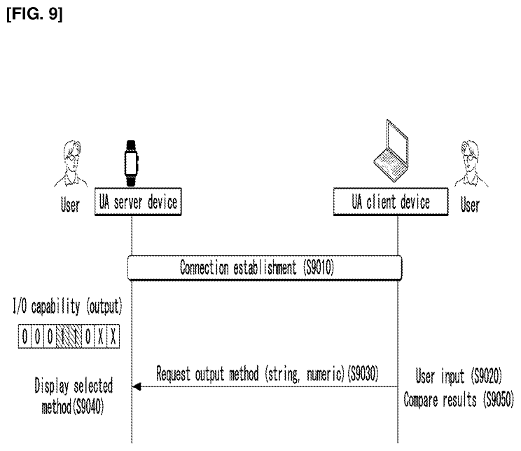

FIG. 9 is a diagram illustrating an example in which a UA server device having a method of outputting a character string and a number performs a proximity check procedure.

In FIG. 9, a bit string representing an I/O capability of the UA server device is illustrated, a bit ‘1’ indicates that the I/O capability is provided, and a bit ‘0’ indicates the opposite.

In FIG. 9, it can be seen that the UA server device has two types of I/O output capabilities.

First, the UA server device establishes a connection with the UA client device (S9010).

Thereafter, the user of the UA client device inputs a specific value as an input value to the UA client device (S9020).

Specifically, because the I/O output capability of the UA server device supports character strings and numeric values, the input value may be a character string or a numeric value.

Thereafter, the UA server device receives an output method request message from the UA client device.

The output method request message may include information on an output method selected by the UA client device.

Thereafter, the UA server device outputs an output value of a specific value in the selected method (S9040).

Thereafter, the UA client device compares the input value input by the user with the output value output by the UA server device (S9050).

In this case, the output value is output by the output method selected by the UA client device, and when the input value and the output value match, the proximity check procedure is successful.

Information Required for Registration Method

Hereinafter, information on the UA server device and the UA client device required in the above-described registration method (or registration phase) will be described.

First, information required in the UA server device will be described.

Information required in the UA server device is as follows.
Server-Device-ID: This means a self-identification value of the server device, and has better uniqueness.
Client-DeviceID: This is received from an available authentication method (AAM) request message of the UA client device.
AAM: This is an authentication function of the UA server. It is a set of bit flags indicating each user authentication method. For example, it is as follows.
Wearing (& clasped): This is a 1-bit flag that can distinguish whether a user is wearing a UA server device.
Biometric-Fingerprint: This is a 1-bit flag indicating whether user authentication using a fingerprint is available.
Biometric-IRIS: This is a 1-bit flag indicating whether user authentication using biometric-IRIS is available.
Chosen Authentication Method: This is a method chosen by the UA client. Bit flags are listed in the same order as the available authentication method information. Only bits in the available method are set.
UAS-Registered-ID: This is an ID generated by the UA server in order to identify the client device ID, server device ID, and chosen authentication method pair. This ID should be unique.
Shared key: This is a shared encryption/decryption key for transactions. The derived 128-bit key forms a 256-bit ECDH key.

Thereafter, information required in the UA client device will be described.

Information required in the UA client device is as follows.
Client-Device-ID: This means a self-identification value of the client device, and has better uniqueness.

Further, the client device ID may have two or more levels in order to indicate other domains (e.g., office and home).

For example, the client device ID may have two levels such as A-Office: A-Notebook and B-Home: A-Notebook.

That is, the same notebook computer may be in different domains. In this case, the actual login level may vary depending on the domain.

As another example, there may be several door locks or several laptop computers from the same company.

The IDs of each UA client device are as follows.

A-Company: A-Notebook, A-Company: B-notebook or A-Company: A-Department-Doorlock, A-Company: B-Department-Doorlock.

In this case, for convenience, a company manager may register several notebook computers or several door locks, which are UA client devices, in the UA server device.

An individual employee receives a UA server device having registration information for individual notebook computers or department door locks from the manager.

Using the UA server device, the individual employee may perform user authentication for the notebook computer or the door lock.
UAS-Registered-ID: When registration is completed, it is received from the UA server and used as a query parameter in the usage phase.
Chosen authentication method: This is a method selected by the UA client and transmitted to the UA server device in the registration phase.
Shared-Key: This is a shared encryption/decryption key for transactions. The derived 128-bit key forms a 256-bit ECDH key.

Usage phase-Method (2)

Hereinafter, operation of the UA server device and the UA client device will be described in the usage phase (method).

The usage phase (method) refers to a phase in which a user performs user authentication to the UA client device using the chosen authentication method in the registration phase through the UA server device.

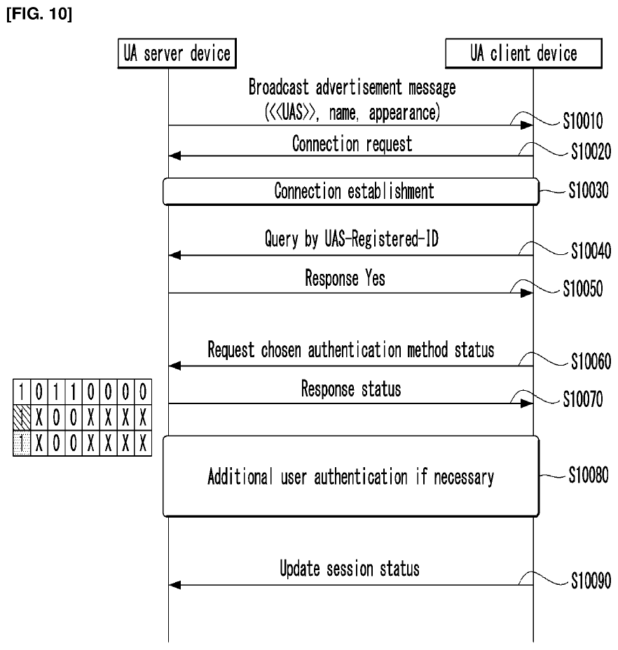

FIG. 10 is a diagram illustrating an example of a usage phase using a UA server device.

In FIG. 10, a UA server device and a UA client device are illustrated.

In FIG. 10, the UA client device completes a registration procedure and is registered in the UA server device.

First, the UA server device broadcasts an advertisement message (S10010). The advertisement message may include information such as a name, appearance, or address of the UA server device.

Thereafter, the UA server device receives a connection request message from the UA client device (S10020).

The UA client device may transmit the connection request message to the UA server device only when the advertisement message is received.

The UA client device may transmit a connection request message only to an interested UA server device.

Specifically, when the UA client device is registered in the UA server device, the UA client may know partial information of the UA server device.

The partial information may include a name, appearance, or address of the UA server device.

The UA client device may transmit a connection request message only to an interested UA server device using the partial information.

More specifically, the UA client device may generate a white list filter based on the partial information, and receive advertisement messages from the UA server devices using the white list filter, thereby transmitting a connection request message only to the interested UA server device.

Thereafter, the UA server device receives a connection request message from the UA client device (S10020).

Thereafter, the UA server device and the UA client device establish a connection (S10030).

Thereafter, the UA server device receives, from the UA client device, a request message requesting a query (confirmation) on whether the UA server device has a UAS-Registered-ID associated with the UA client device (S10040).

The request message may also be represented as a UAS-Registered-ID confirmation request message or a UAS-Registered-ID query message.

Thereafter, because the UA client device has been registered in the UA server device, the UA server device transmits a response message including response information ‘Yes’ to the UA client device (S10050).

The response message may also be represented as a UAS-Registered-ID confirmation response message or a UAS-Registered-ID query response message.

The UAS-Registered-ID confirmation response message may include a ‘yes’ response or a ‘no’ response.

When there is a UAS-Registered-ID associated with the UA client device in the UA server device, a ‘Yes’ response is included in the UAS-Registered-ID confirmation response message.

If the UAS-Registered-ID does not exist in the UA server device, a ‘No’ response is included in the UAS-Registered-ID confirmation response message.

Thereafter, the UA server device receives a request message for requesting information related to a chosen authentication method status (CMS) from the UA client device (S10060).

The information may also be represented as authentication method status information or CAMS information.

The request message may also be represented as an authentication method status request message or a CAMS request message.

The authentication method status information indicates a current authentication status in the UA server device of the authentication methods selected by the UA client device in the registration phase.

More specifically, in the registration phase, when the UA client device selected wearing, biometric-fingerprint, and biometric-IRIS methods, and when only the wearing and biometric-IRIS methods are currently authenticated in the UA server device, information that only the wearing and biometric-IRIS methods are authenticated may be included in the authentication method status message.

The information may be configured with various types of data, and for example, the information may be configured in the form of a bit string.

In this case, a bit 1 may indicate that it is authenticated, and a bit 0 may indicate that it is not authenticated. The opposite is also possible.

Returning to FIG. 10, when the UA client device received a UAS-Registered-ID confirmation response message including a ‘No’ response in step S10050, the UA client device may not transmit an authentication method status request message to the UA server device.

Thereafter, the UA server device transmits a response message including the authentication method status information to the UA client device (S10070).

The response message may also be represented as an authentication method status response message or simply a CAMS response message.

The UA client device may determine whether to actually perform a work based on authentication method state information included in the authentication method state response message.

That is, when the authentication method state information indicates that all chosen authentication methods have been authenticated, the UA client device completes user authentication and performs a session status update step (S10090).

Conversely, when the authentication method status information indicates that there is an unauthenticated method among the chosen authentication methods, an additional procedure may be performed to satisfy all conditions negotiated in the registration phase between the UA server device and the UA client device (S10080).

For example, when only the wearing method is authenticated among the wearing, biometric-fingerprint, and biometric-IRIS methods selected in the registration phase, an additional user authentication phase may be performed.

When additional user authentication is successful in the additional user authentication phase, a session status update phase may be performed (S10090).

Conversely, when additional user authentication fails in the additional user authentication phase, the connection between the UA server device and the UA client device may be released.

In the above-described usage phase procedure S10010 to S10090, after an initial confirmation request of the UAS-Registered-ID of the UA client (i.e., after step S10040), it may be desirable for security reasons that the remaining transactions between the UA server device and the UA client device are encrypted.

Through such a usage phase, it is possible to perform a user authentication procedure even in a client device that is not equipped with a user authentication means (e.g., biometric-fingerprint sensor, a biometric-IRIS sensor, etc.) through a server device equipped with a user authentication means and thus there is an effect that a security level for obtaining the access right of the client device can be strengthened.

Further, without user authentication through complex password input in a client device that is not equipped with a user authentication means (e.g., biometric-fingerprint sensor, biometric-IRIS sensor, etc.), the user can obtain client device use rights using the authentication method registered in the server device, thereby increasing user convenience.

Information required for use method

Hereinafter, information required for the UA server device and the UA client device in a usage phase will be described.

First, information required for the UA server device in the usage phase will be described first.
UAS-Registered-ID: This is used for query parameters from UA clients.
Shared key: This is a shared encryption/decryption key for transactions. The derived 128-bit key forms a 256-bit ECDH key. Unlike in the registration phase, another actual key is derived from nonce to prevent replay attacks.
Current authentication method status: This is an individual authentication method status in the UA server, may be changed dynamically, and transmitted to the UA client device. The information is configured in the form of a set of status bit flags for each authentication method. It is configured in the same bit order as that of the available authentication methods in the UA server device.
Session authentication status: This represents a session authentication status of the UA server device and the UA client device. It is used for synchronizing an authentication status between the UA server device and the UA client device. When an authentication check procedure is completed, the UA client device transmits session authentication status information to the UA server device. When authentication fails, the UA server device transmits session authentication status information to the UA client.

Thereafter, information required for the UA client device in the usage phase will be described.
UAS-Registered-ID: This is used as a query parameter for the UA server.
Shared key: This is a shared encryption/decryption key for transactions. The derived 128-bit key forms a 256-bit ECDH key. Unlike in the registration phase, another actual key is derived from nonce to prevent replay attacks.
Chosen authentication method: This is used for checking a status of a user authentication method selected by the UA client device in the registration phase. It is configured in the same bit order as that of available authentication methods of the UA server device.
Session authentication status: This represents a session authentication status of the UA server device and the UA client device. It is used for synchronizing an authentication status between the UA server device and the UA client device. When the authentication check procedure is completed, the UA client device transmits session authentication status information to the UA server device. When authentication fails, the UA server device transmits session authentication status information to the UA client.

Communication Channel Encryption Method

User authentication is performed within a security environment of the server, and the server generates the same authentication result when the same conditions are requested together with a UAS-Registered-ID.

Further, in order for data to be transmitted securely between the UA server device and the UA client device, the data should be encrypted.

In the registration phase, the UA server device and the UA client device generate a shared key.

In the registration phase, the shared key is used as it is. However, in the usage phase, the shared key is derived from nonce to prevent a replay attack.

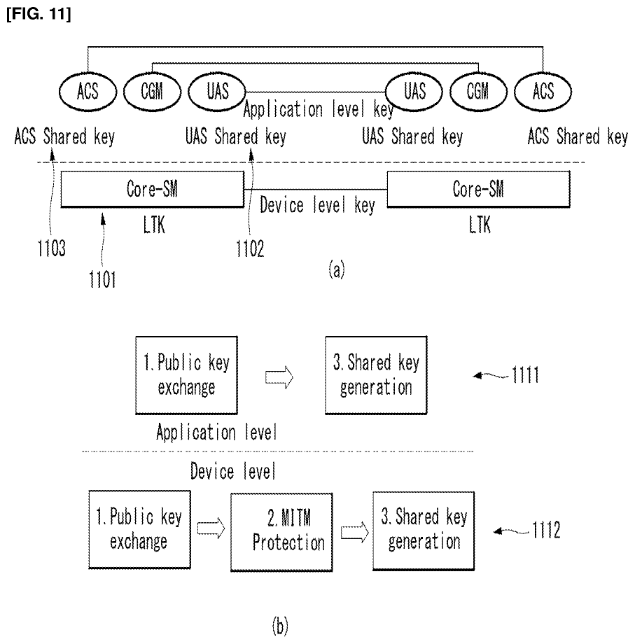

FIG. 11(a) is a diagram illustrating an example of a device-level and application-level data encryption method.

As illustrated in FIG. 11(a), a user authentication service may use a Core Security Manager (Core-SM) with device-level security (1101).

Further, a shared Long Term Key (LTK) is used for device-level encryption/decryption that shares all of the above applications.

As illustrated in FIG. 11(a), in order to prevent other applications from peeking UAS data, UAS generates a UAS Shared-key in upper FIG. 1102).

Further, at the top of the device level, each application uses an encryption key at an individual application level in order to prevent application in the middle (AITM) attacks (1102, 1103).

FIG. 11(b) is a diagram illustrating a procedure for generating a shared key at a device level and a procedure for generating a shared key at an application level.

As illustrated in FIG. 11(b), at the device level, in order to generate a shared key, a core security manager performs steps of public key exchange (step 1), MITM protection (step 2), and shared key generation (step 3) (1112).

Application-level key generation follows similar steps.

However, when MITM protection is required, a similar User Interface (UI) screen is requested to the user at both the device level and the application level. This may confuse the user or annoy the user.

Therefore, when MITM protection is performed in the core security manager in order to improve the user experience, it may be desirable to skip a similar MITM protection UI step (step 2) at the application level.

That is, as illustrated in FIG. 11(b), the core security manager may perform steps 1, 2, and 3 (1112), and perform only steps 1 and 3 at the application level (1111).

Through such a communication channel encryption method, there is an effect of reducing user confusion that occurs when both the device level and the application level request a similar user interface (UI) screen to the user.

Various Embodiments to which the Present Disclosure can be Applied

Hereinafter, various embodiments to which the above-described methods are applied will be described.

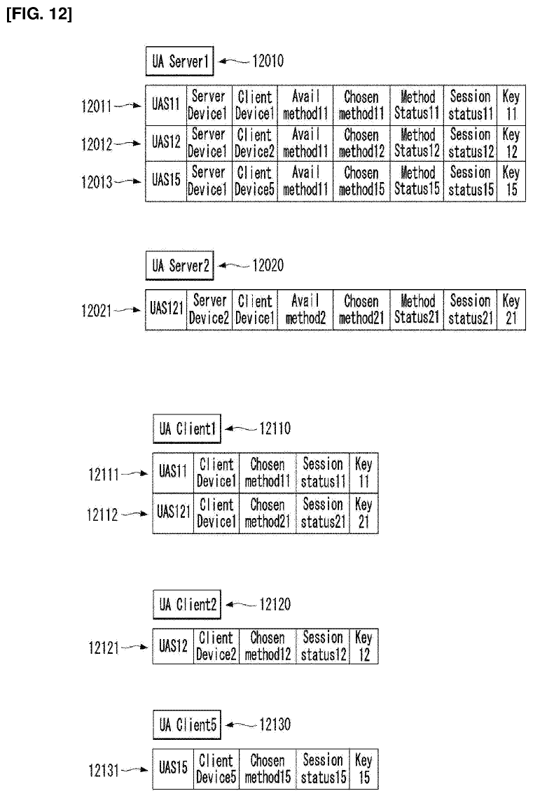

FIG. 12 is a diagram illustrating an example of information on a UA server device and a UA client device used in a usage phase.

In FIG. 12, a first UA server device (UA server 1) 12010 and a second UA server device (UA server 2) 12020, which are UA server devices are illustrated.

Further, a first UA client device (UA client 1), a second UA client device (UA client 2), and a third UA client device (UA client 3), which are UA server devices are illustrated.

The UA server devices and the UA client devices each store necessary information in a usage phase.

Information required in the usage phase may also be represented as usage phase information.

Specifically, the first UA server device stores three usage phase information 12011, 12012, and 12013.

Further, the second UA server device stores one usage phase information 12021.

Further, the first UA client device stores two usage phase information 12111 and 12112.

Further, the second UA client device stores one usage phase information 12121.

Further, the third UA client device stores one usage phase information 12131.

The usage phase information stored by the UA server device includes a UAS Registered-ID, a server device ID, a client device ID, an available authentication method, an authentication method selected in the registration phase, an authentication method status in the server device, a session status, and shared key information.

The usage phase information stored by the UA client device includes a UAS Registered-ID, a client device ID, an authentication method selected by the UA client device in the registration phase, a session status, and shared key information.

The UAS Registered-ID, available authentication method, and authentication method status information in the server device are generated in the UA server device and transmitted to the UA client device.

The client device ID and the authentication method information selected by the UA client device in the registration phase are generated in the UA client device and transmitted to the UA server device.

The session status information is generated by both the UA server device and the UA client device and transmitted to each other.

The shared key information is generated by each of the UA server device and the UA client device, but the shared key information is not transmitted to each other.

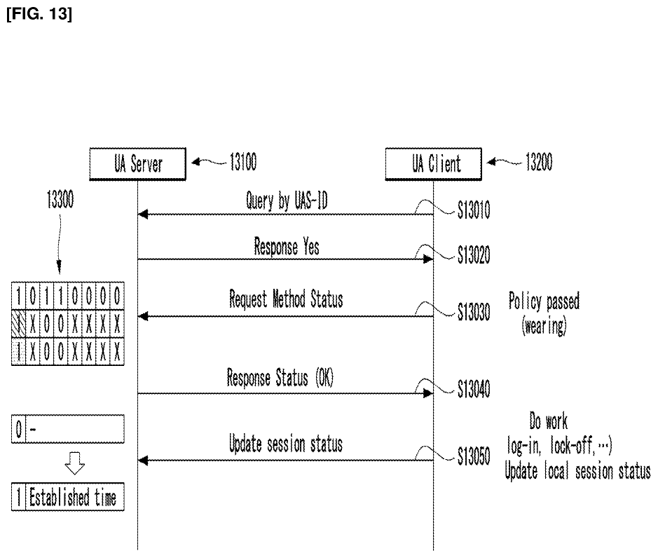

FIG. 13 is a diagram illustrating an example of a process of performing user authentication of a UA client device using a UA server device in a usage method.

In FIG. 13, a UA server device 13100 and a UA client device 13200 are illustrated.

The UA server device 13100 registers the UA client device 13200 in a registration phase, and performs a usage phase with the UA client device.

First, the UA server device 13100 receives a request message for requesting a query by a UAS-Registered-ID from the UA client device 13200 (S13010).

The UAS-Registered-ID may be simply represented as a UAS-ID.

Further, the request message may be represented as a UAS-ID query request message.

Thereafter, the UA server device transmits a response message to the UAS-ID query request message including information ‘Yes’ (S13020).

The response message may be represented as a UAS-ID query response message.

The UAS-ID query response message may include information ‘no’.

In step S13020 of FIG. 13, because the UAS-ID query response message was transmitted including information ‘Yes’, the UA server device receives, from the UA client device, a request message for requesting information related to a currently chosen authentication method status (CMS) by the UA client device in the UA server device (S13030).

The request message may also be represented as a chosen authentication method status (CAMS) request message or a CAMS request message.

The CAMS information indicates a status currently authenticated in the UA server device of chosen authentication methods in the registration phase by the UA client device.

In FIG. 13, an example of available CAMS information 13300 is illustrated.

A first line of the CAMS information indicates an available authentication method in the server device, a second line thereof indicates an authentication method selected by the UA client device in the registration phase, and a third line thereof indicates a current authentication method status.

A bit ‘1’ means available in the first line, means selected in the second line, and in the third line, it may mean that the corresponding authentication method is currently authenticated by the UA server device.

A bit ‘0’ may have the opposite meaning to the above-described bit ‘1’.

A bit marked with X is an invalid value set for an authentication method in which the UA server device does not support.

Specifically, because the first bit, third bit, and fourth bit of the first line are set to 1, there are three authentication methods that the UA server device can use.

Further, because only the first bit of the second line is set to 1, and the third bit and the fourth bit thereof are set to 0, there is one authentication method selected by the UA client device.

Further, because the first bit of the third line is set to 1, it can be seen that the chosen authentication method is in an authentication state in the UA server device.

Thereafter, after receiving the CAMS request message, the UA server device transmits a response message including CAMS information in response thereto (S13040).

The response message may be represented as an authentication method status response message or a CAMS response message.

The authentication method response message may include information ‘OK’ or ‘More’ according to the chosen authentication method and the current authentication method state in the UA server device.

More specifically, when all of the chosen authentication methods are in an authenticated state, an authentication method status response message including information OK is transmitted.

Further, when at least one of the chosen authentication methods is not authenticated, an authentication method status response message is transmitted including information ‘More’ indicating that additional authentication is required.

When the information ‘More’ is included, information indicating which of the chosen authentication methods has not been authenticated may be included.

In the example of FIG. 13, because all currently chosen authentication methods have been authenticated, the authentication method status response message is transmitted including information ‘OK’.

Thereafter, the UA server device receives a message notifying update of session authentication from the UA client device (S13050).

In the session authentication update process, user authentication (e.g., login, lock-off, etc.) may be completed in the UA client device.

The user can perform a work using the UA client device, thereby completing the usage phase.

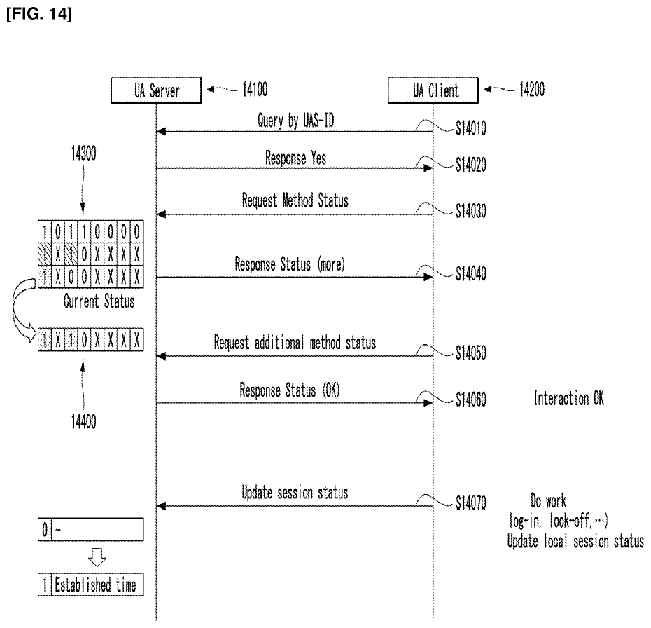

FIG. 14 is a diagram illustrating another example of a process in which user authentication is performed between a UA server device and a UA client device in a usage phase.

In FIG. 14, a UA server device 14100 and a UA client device 14200 are illustrated.

The UA server device 14100 registers the UA client device 14200 in a registration phase, and performs a usage phase with the UA client device.

First, the UA server device 14100 receives a request message for requesting a query by a UAS-Registered-ID from the UA client device 14200 (S14010).

The UAS-Registered-ID may be simply represented as a UAS-ID, and the request message may be represented as a UAS-ID query request message.

Thereafter, the UA server device transmits a response message to the UAS-ID query request message including information ‘Yes’ (S14020).

The response message may be represented as a UAS-ID query response message.

The UAS-ID query response message may include information ‘no’.

In step S14020 of FIG. 14, because the UAS-ID query response message including information ‘Yes’ was transmitted, the UA server device receives, from the UA client device, a request message for requesting information related to a currently chosen authentication method status (CMS) by the UA client device in the UA server device (S14030).

The request message may also be represented as a first chosen authentication method status (CAMS) request message or a first CAMS request message.

The CAMS information indicates a status currently authenticated in the UA server device of authentication methods selected by the UA client device in the registration phase.

In FIG. 14, an example of CAMS information 14300 is illustrated.

A first line of the CAMS information indicates an available authentication method in the server device, a second line thereof indicates an authentication method selected by the UA client device in the registration phase, and a third line thereof indicates a current authentication method status.

A bit ‘1’ means available in the first line, means selected in the second line, and in the third line, it may mean that the corresponding authentication method is currently authenticated by the UA server device.

A bit ‘0’ may have the opposite meaning to the above-described bit ‘1’.

A bit marked with X is an invalid value set for an authentication method that the UA server device does not support.

Specifically, because the first bit, third bit, and fourth bit of the first line are set to 1, there are three authentication methods that the UA server device can use.

Further, because the first bit and the third bit of the second line are set to 1 and the fourth bit thereof is set to 0, there are two authentication methods selected by the UA client device.

The chosen authentication methods may be wearing (first bit) and biometric-fingerprint (third bit), respectively.

Further, because only the first bit of the third line is set to 1, it can be seen that only one of the selected two authentication methods (first bit) is in an authentication state in the UA server device.

Specifically, authentication through biometric-fingerprint may be required.

Thereafter, after receiving a first CAMS request message, the UA server device transmits a response message including CAMS information in response thereto (S14040).

The response message may be represented as a first CAMS response message.

The first CAMS response message may include information ‘OK’ or ‘More’ according to the chosen authentication method and the current authentication method state.

More specifically, when all of the chosen authentication methods are in an authenticated state, a CAMS response message including information OK is transmitted.

Further, when there is an authentication method that is not in an authenticated state among the chosen authentication methods, a CAMS response message is transmitted including information ‘More’ indicating that additional authentication is required.

In the example of FIG. 14, because there is an authentication method that is not currently authenticated among the chosen authentication methods, the CAMS response message is transmitted including More information.

Thereafter, the UA server device receives a request message requesting an additional authentication method status from the UA client device (S14050).

The request message may be represented as a second CAMS request message.

The UA server device, has received the second CAMS request message, will request fingerprint authentication to the user, and the user may perform authentication through fingerprint authentication with the UA server device.

Thereafter, the UA server device transmits a second CAMS response message to the

UA client device (S14060).

In the example of FIG. 14, after step S14050, as a result that the user performs authentication through biometric-fingerprint, a third bit of the third line set to 0 when receiving the first CAMS request message is set to 1 when receiving the second CAMS request message (14400).

Accordingly, because all of currently chosen authentication methods have been authenticated, the second CAMS response message is transmitted including information ‘OK’ (S14060).

Thereafter, the UA server device receives a message notifying the update of session authentication from the UA client device (S14070).

The UA client device, having received the CAMS response message including information OK, performs a work (e.g., login, lock-off, etc.), thereby completing the usage phase.

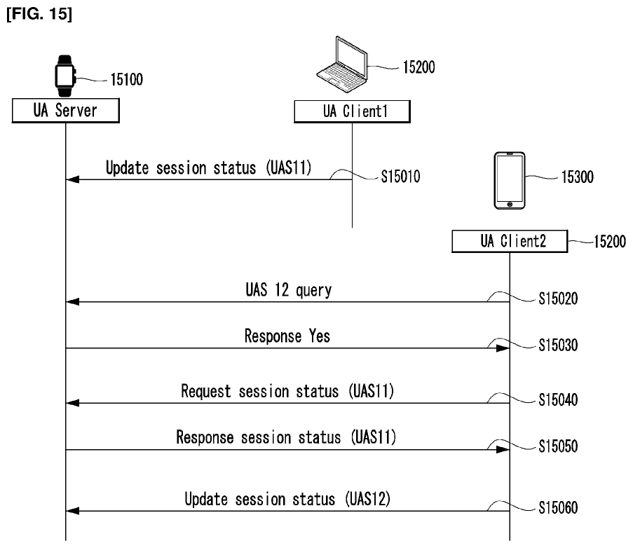

FIG. 15 is a diagram illustrating an example of a method of performing a usage phase with a plurality of UA client devices through one UA server device.

In FIG. 15, a first UA server device 15100 is illustrated.

Further, a first UA client device 15200 and a second UA client device 15300 are illustrated.

It is assumed that both the first UA client device and the second UA client device belong to the same user.

Further, the first UA client device and the second UA client device are both registered in the first UA server device.

Further, when there is a UAS-Registered-ID called UAS NM, this is defined as meaning that it is a UAS-Registered-ID between the N-th UA server device and the M-th client device.

For example, UAS12 corresponds to a UAS-Registered-ID between a first UA server device and a second UA client device.

First, the first UA client device updates a session (UAS 11) between the first UA server device and the first UA client device (S15010).

That is, although not illustrated in FIG. 15, the first UA server device and the first UA client device complete the above-described usage phase, and the user obtains the right to use the first UA client device.

Thereafter, the first UA server device receives, from the second UA client device, a request message for requesting confirmation (query) on whether UAS 12 is registered in the first server device (S15020).

The request message may also be represented as a UAS-Registered-ID confirmation request message or a registration identifier query request message.

The registration identifier confirmation request message is transmitted to determine whether the second UA client device is registered in the first UA server device.

Thereafter, because the second UA client device is registered in the first UA server device, the first UA server device transmits a response message including response information of ‘Yes’ to the second UA client device (S15030).

The response message may also be represented as a UAS-Registered-ID confirmation response message.

If the second UA client device is not registered in the first UA server device, a response message including information “No” may be transmitted.

Further, when information ‘No’ is included, steps after step S15030 may not be performed.

Thereafter, the first UA server device receives, from the second UA client device, a session status request message for requesting information on a session (UAS11) state between the first UA server device and the first UA client device (S15040).

Thereafter, the first UA server device transmits a session status response message to the second UA client device in response to the session status request message (S15050).

The session status response message includes information on a session (UAS11) state formed between the first UA server device and the first UA client device.

The information on the session (UAS11) state may also be represented as session status information.

Thereafter, the second UA client device updates the state of the session (UAS12) formed between the first UA server device and the second UA client device based on the state information (S15060).

That is, the user obtains the right to use the second UA client device (completes user authentication).

In this case, in the step S15060, in order to obtain use rights for the second UA client device, the user may not go through a separate user authentication process (e.g., biometric-fingerprint, biometric-IRIS, etc.) from the second UA client device.

Specifically, even if the second UA client device does not perform a user authentication process separately from the second UA client device using the first UA server device based on the information on the session (UAS11) state received in step S15050, the second UA client device gives the right to use to the user.

In step S15010, when the first UA server device fails to authenticate with the first UA client device, the update of the session (UAS12) may fail in step S15060.

Through the above method, the user can obtain use rights for a plurality of UA client devices without performing user authentication multiple times, thereby increasing convenience.

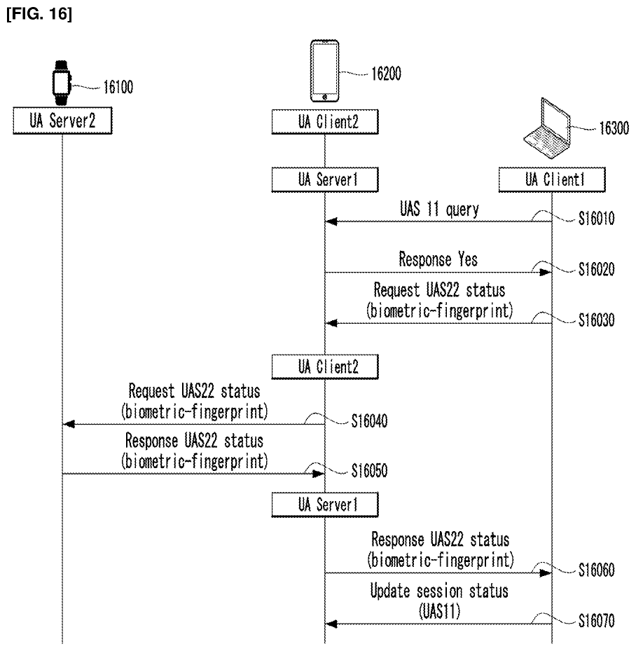

FIG. 16 is a diagram illustrating an example of a method of enabling another UA client device to use another user authentication means using a device that performs both roles of a UA server device and a UA client device.

In FIG. 16, a first device 16100 serving as a second UA server device is illustrated.

Further, a second device serving as a first UA server device and a second UA client device is illustrated.

Further, a third device 16300 serving as a first UA client device is illustrated.

A connection has been established between the second UA server device and the second client device, and registration and authentication phases have been completed.

Further, a connection is established and a registration phase has been completed between the first UA server device and the first UA client device.

The second device (the first UA server device) does not have a biometric-fingerprint method, but the first device (the second server device) has a biometric-fingerprint method.

Because the first UA client device has been currently registered only in the first UA server device (the second device) that does not have a biometric-fingerprint method, the first UA client device wants to be registered in the second server device (the first device) with the biometric-fingerprint method.

Further, when there is a UAS-Registered-ID called UAS NM, this is defined as meaning that it is a UAS-Registered-ID between the N-th UA server device and the M-th client device.

For example, UAS12 corresponds to a UAS-Registered-ID between a first UA server device and a second UA client device.

First, the first UA server device receives a UAS11 registration identifier confirmation request message from the first UA client device (S16010).

Thereafter, the first UA server device transmits a registration identifier confirmation response message to the first UA client device (S16020).

Because the first UA client device is registered in the first UA server device, the registration identifier confirmation response message includes a ‘yes’ response.

Thereafter, the first UA server device receives, from the first UA client device, a UAS 22 status request message for requesting information related to the authentication method status negotiated between the second server UA device and the second UA client device (S16030).

The information may also be represented as UAS 22 authentication method status information.

The UAS 22 status request message may include information that the first UA client device wants to use a biometric-fingerprint method as a user authentication method.

Thereafter, the first UA server device changes a role thereof to the second UA client device.

Thereafter, the second UA client device (the second device) relays the UAS 22 status request message to the second server device (S16040).

Thereafter, the second UA client device receives a UAS22 status response message including UAS 22 authentication method status information from the second UA server device (S16050).

The UAS 22 status response message may include information related to a biometric-fingerprint method.

Thereafter, the second UA client device (the second device) changes a role thereof to the first UA server device.

Thereafter, the first UA server device relays the UAS 22 status response message to the first UA client device (S16060).

Thereafter, the first UA server device (the second device) receives a session status update message indicating that the status of a session (UAS11) formed between the first UA server device and the first UA client device has been updated from the first UA client device.

The first UA client device may update a session (UAS11) status based on the received UAS 22 state response message.

After completing the above procedures, the first UA client device may perform user authentication using a biometric-fingerprint method through the second UA server device.

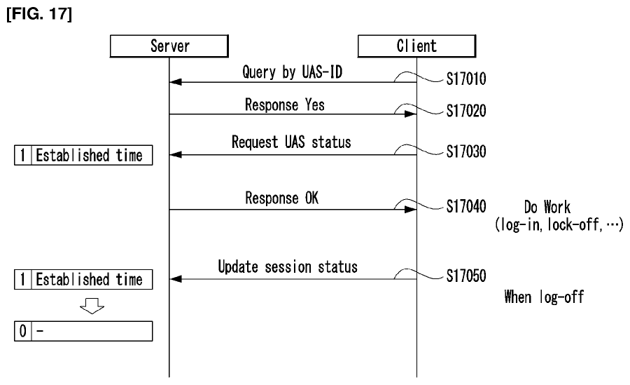

FIG. 17 is a diagram illustrating an example of a process in which a session status is updated in a usage phase between a UA server device and a UA client device in a usage phase.

In FIG. 17, a UA server device and a UA client device are illustrated.

It is assumed that the UA server device is in a state in which the UA client is registered through the registration phase with the UA client device.

Further, it is assumed that all authentication methods of the UA server device are currently in an authentication state.

First, the UA server device receives, from the UA client device, a request message for requesting confirmation on whether the UA client is registered in the UA server device (S17010).

Thereafter, the UA server device transmits a response message including information ‘yes’ to the UA client device (S17020).

Thereafter, the UA server device receives a UAS status request message from the UA client device (S17030).

The UAS status request message includes information on a current authentication status of user authentication methods selected by the UA client device in the registration phase in the UA server device.

Thereafter, the UA server device transmits a response message to the UAS status request message to the UA client device (S17040).

The response message includes information OK because all of the current authentication methods are in an authentication state.

Thereafter, the UA server device receives a message indicating update of a session status from the UA client device (S17050).

The session status may be updated by logging off by the user in the UA client device.

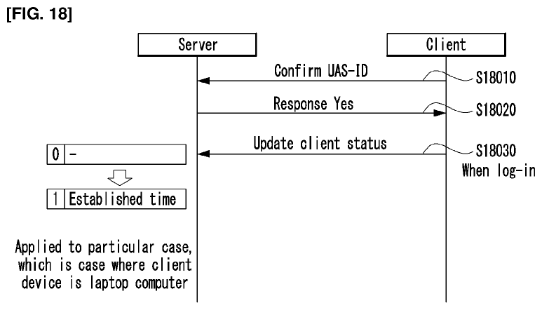

FIG. 18 is a diagram illustrating another example of a process in which a session status is updated in a usage phase between a UA server device and a UA client device in a usage phase.

It is assumed that the UA server device is in a state in which the UA client is registered through the registration phase with the UA client device.

First, the UA server device receives, from the UA client device, a request message for requesting confirmation on whether the UA client is registered in the UA server device (S18010).

Thereafter, the UA server device transmits a response message including information ‘yes’ to the UA client device (S18020).

Thereafter, the UA server device receives a message indicating update of a session status from the UA client device (S18030).

The session status may be updated by authenticating the user to the UA client device by itself without using the UA server device.

More specifically, the UA client device may be a notebook computer, and a user may log-in to the notebook computer by himself, thereby updating a session status.

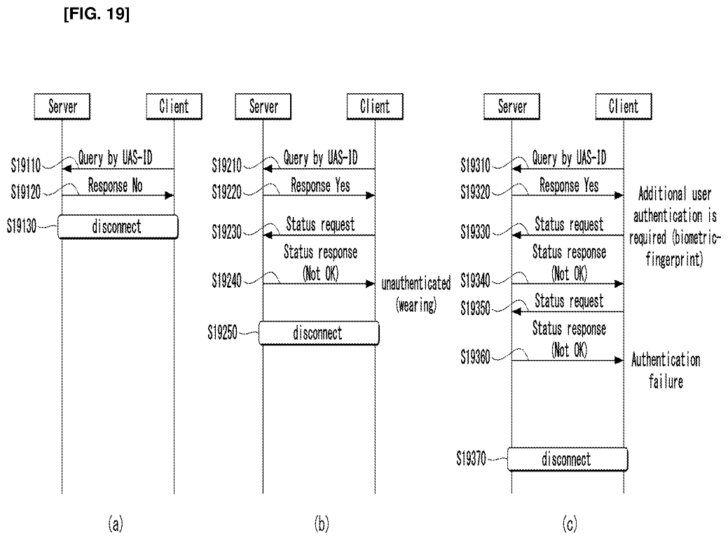

FIG. 19 is a diagram illustrating examples in which user authentication fails in a usage phase between a UA server device and a UA client device.

In FIG. 19(a), a UA server device and a UA client device are illustrated.

The UA server device is not registering the UA client device.

First, the UA server device receives, from the UA client device, a request message for requesting confirmation on whether the UA client is registered in the UA server device (S19110).

Thereafter, because the UA server device does not register the UA client device, the UA server device transmits a response message including information ‘No’ to the UA client device (S19120).

Because the UA server device does not register the UA client, the response message may be transmitted without encryption.

Thereafter, the connection formed between the UA server device and the UA client device is released (S19130).

In FIG. 19(b), a UA server device and a UA client device are illustrated.

The UA server device is registering the UA client device.

Further, at least one of the user authentication methods selected by the UA client device in the registration phase is not currently authenticated by the UA server device.

First, the UA server device receives, from the UA client device, a request message for requesting confirmation on whether the UA client device is registered in the UA server device (S19210).

Thereafter, because the UA server device registers the UA client device, the UA server device transmits a response message including information ‘Yes’ to the UA client device (S19220).

Because the UA server device registers the UA client device, the response message may be encrypted and transmitted.

Thereafter, the UA server device receives, from the UA client device, a request message for requesting information on the current authentication status of the chosen authentication means in the UA server device (S19230).

Thereafter, because at least one of the chosen authentication methods is not authenticated, the UA server device transmits a response message including information indicating that at least one of the chosen authentication methods has not been authenticated to the UA client device (S19240).

Thereafter, the connection formed between the UA server device and the UA client device is released (S19250).

In FIG. 19(c), a UA server device and a UA client device are illustrated.

The UA server device registers the UA client device.

Further, at least one of the user authentication methods selected by the UA client device in the registration phase is not currently authenticated by the UA server device.

First, the UA server device receives, from the UA client device, a request message for requesting confirmation on whether the UA client device is registered in the UA server device (S19310).

Thereafter, because the UA server device registers the UA client device, the UA server device transmits a response message including information ‘Yes’ to the UA client device (S19320).

Because the UA server device registers the UA client device, the response message may be encrypted and transmitted.

Thereafter, the UA server device receives, from the UA client device, a request message (first request message) for requesting information on a current authentication status of the chosen authentication means in the UA server device (S19330).

Thereafter, because at least one of the chosen authentication methods is not authenticated, the UA server device transmits, to the UA client device, a response message (first response message) including information indicating that additional authentication is required (S19340).

Thereafter, the UA server device again receives, from the UA client device, a request message (second request message) for requesting information on a current authentication status of the chosen authentication means in the UA server device (S19350).

Thereafter, because at least one of the chosen authentication methods is in a state that is not authenticated, the UA server device transmits a response message (second response message) including information indicating that at least one of the chosen authentication methods has not been authenticated to the UA client device (S19360).

Thereafter, the connection formed between the UA server device and the UA client device is released (S19270).

In the example of FIG. 19, when at least one of the chosen authentication methods is in an unauthenticated state, the second request message is transmitted only once more, but after the second request message, a request message for requesting information on the current authentication state may be additionally transmitted.

That is, the UA server device may further receive, from the UA client device, a request message (e.g., a third request message, etc.) for requesting information on the current authentication status of the chosen authentication means in the UA server device.

Furthermore, although each drawing has been described separately for convenience of description, it is also possible to design to implement a new embodiment by merging the embodiments described in each drawing. Further, designing a computer readable recording medium on which a program for executing the previously described embodiments is recorded is also within the scope of the present disclosure according to the needs of those skilled in the art.

A method of performing user authentication using a second device according to the present disclosure is not limited to the configuration and method of the embodiments described as described above, but all or some of the embodiments may be selectively combined and configured so that various modifications may be made.

Further, because various substitutions, modifications, and changes are possible within the scope of the technical spirit of the present disclosure to those of ordinary skill in the technical field to which the present disclosure belongs, the present disclosure is not limited by the above-described embodiments and the accompanying drawings.

In the present disclosure, both the product disclosure and the method disclosure have been described, and the description of both disclosures may be applied supplementarily as necessary.

### INDUSTRIAL AVAILABILITY

The present disclosure relates to a method and apparatus for performing user authentication using Bluetooth, which is short-range technology, in a wireless communication system, and more particularly, to a method and apparatus for performing user authentication for enabling a user to use a first device using a second device equipped with a user authentication function.

1. A method of performing user authentication of a first client device using a server device in a wireless communication system, the method performed by the server device comprising:
broadcasting a first advertisement message for a connection with a first client device;
establishing a connection with the first client device;
receiving, from the first client device, a first request message for requesting at least one authentication method supported by the server device;
transmitting, to the first client device, a first response message comprising first authentication method information related to the at least one authentication method;
receiving, from the first client device, a setting message comprising second authentication method information related to one or more authentication methods of the at least one authentication method; and
transmitting a second response message comprising a first user authentication service (UAS) registration identifier to the first client device,
wherein the first UAS registration identifier indicates the first client device for performing user authentication through the one or more authentication methods and the one or more authentication methods.

2. The method of claim 1, wherein the first advertisement message comprises UAS Universally Unique Identifier (UUID) information, name information of the server device, and appearance information of the server device.

3. The method of claim 1, wherein the first UAS registration identifier is generated based on a first client device identifier, a server device identifier, and the one or more authentication methods.

4. The method of claim 1, further comprising:
registering the first client device and the one or more authentication methods.

5. The method of claim 1, wherein the at least one authentication method comprises at least one of wearing, biometric-fingerprint, biometric-IRIS, and biometric-EEG.

6. The method of claim 1, further comprising:
exchanging a public key for generating a shared key with the first client device,
wherein the public key is generated in each of the first client device and the server device.

7. The method of claim 6, further comprising:
generating the shared key based on the public key,
wherein the shared key is used for encrypting messages transmitted after the shared key is generated.

8. The method of claim 1, further comprising:
receiving, from the first client device, a first inquiry message inquiring whether the first UAS registration identifier exists;
determining whether the first UAS registration identifier exists;
transmitting, to the first client device, a message related to whether the first client device is registered;
receiving, when the first UAS registration identifier exists, a third request message, from the first client device, for requesting first authentication status information, which is information on whether a user has been authenticated through the one or more authentication methods; and
transmitting a third response message comprising the first authentication status information to the first client device.

9. The method of claim 8, further comprising:
broadcasting, when the connection is released, a second advertisement message for a connection with the first client device; and
re-establishing a connection with the first client device.

10. The method of claim 8, further comprising:
releasing the connection when the first UAS registration identifier does not exist.

11. The method of claim 8, wherein messages exchanged between the first client device and the server device are encrypted and exchanged after the first inquiry message.

12. The method of claim 8, further comprising:
receiving a session status update message indicating that a session status formed between the first client device and the server device is updated from the first client device, when the authentication state information indicates that all of the one or more authentication methods have been authenticated.

13. The method of claim 8, further comprising:
receiving, from the first client device, a fourth request message for requesting second authentication state information, when the first authentication state information indicates that there is an unauthenticated authentication method among the one or more authentication methods; and
transmitting a fourth response message comprising the second authentication status information to the first client device.

14. The method of claim 1, further comprising:
receiving, from the first client device, a session status update message indicating that a session status formed between the first client device and the server device is updated;
receiving, from a second client device, a second inquiry message inquiring whether a second UAS registration identifier exists;
transmitting, to the second client device, a message related to whether the second client device is registered;
receiving, from the second client device, a session status request message for requesting session status information about a session status formed between the first client device and the server device when the second UAS registration identifier exists; and
transmitting a session status response message comprising the session status information to the second client device,
wherein a session formed between the second client device and the server device is updated based on the session status information.

15. The method of claim 14, wherein the second client device does not transmit the session status request message, when the second UAS registration identifier does not exist.

16. In a method of performing user authentication with a client device using a server device in a wireless communication system, the server device comprising:
a communication unit for transmitting and receiving signals to and from the outside by wired and/or wireless means; and
a control unit functionally connected to the communication unit,
wherein the control unit is configured to:
broadcast a first advertisement message for a connection with the first client,
establish a connection with the first client device,
receive a first request message for requesting at least one authentication method supported by the server device from the first client device,
transmit a first response message comprising first authentication method information related to the at least one authentication method to the first client device,
receive, from the first client device, a setting message comprising second authentication method information related to one or more authentication methods among the at least one authentication method, and
transmit a second response message comprising a first User Authentication Service (UAS) registration identifier to the first client device,
wherein the first UAS registration identifier indicates the first client device for performing user authentication through the one or more authentication methods and the one or more authentication methods.
